(19) United States
(12) Patent Application Publication
(10) Pub. No.: US 2023/0382521 A1
(43) Pub. Date: Nov. 30, 2023

(54) STRUCTURAL FEATURES OF VERTICAL TAKE-OFF AND LANDING (VTOL) AERIAL VEHICLE

(71) Applicant: Deng Huang, Millburn, NJ (US)

(72) Inventor: Deng Huang, Millburn, NJ (US)

(21) Appl. No.: 18/202,350

(22) Filed: May 26, 2023

Related U.S. Application Data
(60) Provisional application No. 63/345,913, filed on May 26, 2022.

(51) Int. Cl. B64C 29/00; B64C 27/24; B64U 10/20

(52) U.S. Cl. CPC B64C 29/0008; B64C 27/24; B64U 10/20

(57) ABSTRACT

An aerial vehicle pertinent to the present application has a rotor system that operates in both a vertical-take-off-landing (VTOL) and a cruise mode. There are boom structures which support rotors and the tail. Tiltable rotors are located at the front ends of the booms. The rear rotors are placed under an upward rise in the booms, which allows for reduced in-flight drag and eliminates the need for collapsible rotors when said rotors are not actively operational.

### CROSS-REFERENCE TO RELATED APPLICATIONS

This application is a U.S. provisional application and as such claims no priority to any patent or patent application.

### FIELD OF THE EMBODIMENTS

The field of the embodiments of the present application relates to aerial vehicles, both manned and unmanned, which have vertical-take-off-landing (VTOL) capabilities. More particularly, the aerial vehicle of the present application has a rotor system that operates in at least two distinct modes: VTOL and cruise. Each of the aforementioned modes allows for different operation of the rotors. Further structural features of the present application allow for reduced in-flight drag and eliminates the need for collapsible rotors.

### BACKGROUND OF THE EMBODIMENTS

Aerial vehicles, both manned and unmanned, can generally be classified as either fixed-wing aircraft or rotary aircraft. Each fixed-wing or rotary aircraft has its distinct advantages and disadvantages. Fixed-wing aircraft can generally achieve greater endurance and range than their rotary-wing counterparts due to their aerodynamic configuration and increased efficiency. This is because the thrust force provided by the propeller is used substantially in its entirety for forward motion and the fixed wings are used to generate lift. However, fixed-wing aircraft generally require a sufficient runway distance for takeoff and landing.

Rotary-wing aircraft, on the other hand, can perform hovering flight and do not require a runway for takeoff, and are generally more maneuverable and positionable than their fixed-wing counterparts. However, they are not as efficient at providing forward motion of the aircraft.

To solve the shortcomings of the aerial vehicles noted above, entities have sought “hybrid” aerial vehicles that combine the features of both fixed-wing and rotary-wing aircraft in an attempt to gain advantages of both systems. Commonly referred to as vertical-take-off-landing (VTOL) aircrafts, these aerial vehicles typically use multiple rotors as part of a vertical propulsion system to provide takeoff and landing as well as other displacement motion in the vertical direction. They may also include fixed wings to provide lift during forward motion. A forward propulsion system can be provided separately, or by repositioning all or part of the vertical propulsion system. VTOL aerial vehicles, both manned and unmanned, have received increased attention in recent years due to their potential uses in air-taxi and e-commerce delivery industries.

A popular configuration for VTOL unmanned aerial vehicles (UAV or UAVs) is a quadrotor UAV that includes four vertical rotors and one or more forward propulsion units (rotors) for cruise flight mode, along with a fixed-wing configuration for lift during cruising. These UAVs typically transition from VTOL mode to forward propulsion mode and back by deactivating one of the rotor systems in accordance with the desired flight mode.

Review of related technology:

U.S. Pat. No. 11,091,258 pertains to an exemplary tiltrotor aircraft having a vertical takeoff and landing (VTOL) flight mode and a forward flight mode includes tiltable rotors located at forward boom ends, tiltable ducted fans located at wings aft of the forward boom ends, and aft rotors located on aft boom portions.

U.S. Pat. No. 10,894,599 pertains to a hybrid multi-rotor aircraft, that includes a plurality of vertical propulsion rotors and at least one forward propulsion rotor. The aircraft also includes a rotor compartment within for each of the vertical propulsion rotors such that a vertical propulsion rotor may be stowed within its respective rotor compartment. A deployable rotor-compartment cover for each rotor compartment is provided and may be moved to an open state to allow the vertical propulsion rotors to be deployed and moved to a closed state to cover their respective vertical propulsion rotors when the vertical propulsion rotors or in a closed state.

U.S. Pat. No. 10,696,392 pertains to an aerial vehicle having a single wing configured for vertical-flight and forward-flight operations. The aerial vehicle includes tilt motor assemblies disposed at a forward end and an aft end of a fuselage. The tilt motor assemblies are configured to orient motors and rotors vertically, horizontally, or at any angle between vertical and horizontal. A pair of parallel booms are mounted beneath the wing on either side of the fuselage. Each of the booms has at least one vertically oriented motor and rotor associated therewith, and a vertical fin extending thereunder. Additionally, a forward tilt motor assembly includes a rotatable extension that is deployed when the motor assembly is configured for vertical flight, enabling the aerial vehicle to land on the vertical fins and the landing rotatable extension.

U.S. Patent Application Publication 2021/0031911 pertains to an aircraft having a canard with a trailing edge, a forward swept and fixed wing having a horizontal plane and a trailing edge, and a plurality of tilt rotors. At least one of the plurality of tilt rotors is attached to the trailing edge of the canard and at least one of the plurality of tilt rotors is attached to the trailing edge of the forward swept and fixed wing. The aircraft also includes a T-tail having a horizontal plane, where the horizontal plane of the T-tail is at a height that is higher than the horizontal plane of the forward swept and fixed wing.

U.S. Patent Application Publication 2016/0229531 pertains to a rotorcraft that includes a proprotor coupled to the wing and a pusher propeller. Power is transferred from the proprotor to the pusher propeller with the use of a torque splitter. The torque splitter contains several gears, including a ring gear which rotates on an axis. The power outputted by the torque splitter is increased or decreased by selectively slowing down the rotation of the ring gear by the use of a clamp.

Thus, various aerial vehicles are known in the art. However, their structure and means of operation are materially different from the present disclosure. The other designs fail to address the problems taught by the present disclosure. At least one embodiment of this invention is presented in the drawings below and will be described in more detail herein.

### SUMMARY OF THE EMBODIMENTS

In general, the present application provides for an aerial vehicle, either manned or unmanned, capable of both vertical-take-off-and-landing (VTOL) and cruise configuration. The embodiments of the present application are particularly applicable for delivery-type drones for retailers and the like. In a preferred embodiment, the aerial vehicle is an unmanned aerial vehicle (UAV). The preferred UAV has two sets of rotors one on the forward portion of the UAV and one towards the rear of the UAV. The front rotors are configured to tilt between an upward position and a forward position. These two positions correspond to vertical takeoff/landing and horizontal flight (cruise), respectively. However, the rear rotors are placed under an upward rise in the boom (the boom being longitudinally extended bodies supporting the tail). In the cruise stage, the rear rotors are inactivated and are “tucked” behind the upward rise in the boom. This reduces the drag and eliminates the need to fold the rear rotors. Furthermore, this structural feature protects the rear rotors from exposure to rain and snow, and reduces the likelihood of freezing in cold weather conditions. Finally, placing rear rotors under the booms allows larger rear blades without moving the tail structure further aft.

In at least one embodiment of the present application, there is an unmanned aerial vehicle (UAV) that includes a vehicle body, a first set of rotors, where the first set of rotors are configured to reside in a first position and a second position, and a second set of downward facing rotors, where the second set of rotors are configured to reside in a first state and a second state.

In another embodiment, there is an unmanned aerial vehicle (UAV) that includes a vehicle body having a wing and a boom, where the boom has an upward rise at a trailing edge of the wing, a first set of rotors, where the first set of rotors are configured to reside in an upward facing and a forward facing position, and a second set of downward facing rotors, where the second set of rotors are configured to reside at an apex of the upward rise in the boom.

The UAV may also include where the boom includes a first boom and a second boom.

The UAV may also include where each of the first set of rotors and the second set of rotors has at least two blades.

The UAV may also include where each rotor of the first set of rotors and the second set of rotors has two blades.

The UAV may also include where a position of the second set of rotors is configured to reduce the drag of the second set of rotors when not in use.

The UAV may also include further includes a coupling member configured to allow for rotation of the first set of rotors from an upward facing position to a forward-facing position. Other technical features may be readily apparent to one skilled in the art from the following figures, descriptions, and claims.

In yet another embodiment there is an unmanned aerial vehicle (UAV) that includes a vehicle body having a wing and a boom, where the boom is coupled to an underside of the wing, and where the boom has an upward rise at a trailing edge of the wing. The UAV also includes a first set of rotors rotatably coupled to the vehicle body via a coupling mechanism, where the first set of rotors are configured to reside in an upward facing and a forward-facing position. The UAV also includes a second set of downward facing rotors, where the second set of rotors are configured to reside at an apex of the upward rise in the boom, and where propellers of the second set of downward facing rotors are configured to be aligned with the boom when not in use.

The UAV may also include where the first position of the first set of rotors is in an upward facing position.

The UAV may also include where the second position of the first set of rotors is in a forward-facing position.

The UAV may also include where the first state of the second set of rotors is in an operative state.

The UAV may also include where the second state of the second set of rotors is in a non-operative state.

The UAV may also include further includes a wing and a boom, where the boom is coupled to an underside of the wing.

The UAV may also include where the boom has an upward rise at the trailing edge of the wing.

The UAV may also include where the first boom and the second boom are coupled via a tail. Other technical features may be readily apparent to one skilled in the art from the following figures, descriptions, and claims.

### BRIEF DESCRIPTION OF THE DRAWINGS

FIG. 1 illustrates a perspective view of an embodiment of the present application.

FIG. 2 illustrates a top view of an embodiment of the present application.

FIG. 3 illustrates a front view of an embodiment of the present application.

FIG. 4 illustrates a side view of an embodiment of the present application.

FIG. 5A illustrates an embodiment of the present application in a VTOL mode.

FIG. 5B illustrates an embodiment of the present application in a cruise mode.

FIG. 6A illustrates a wind tunnel simulation of surface air speed as applied to a known design, where rear rotors are place above the booms.

FIG. 6B illustrates a wind tunnel simulation of surface pressure as applied to a known design, where rear rotors are place above the booms.

FIG. 7A illustrates a wind tunnel simulation of surface air speed as applied to an embodiment of the present application.

FIG. 7B illustrates a wind tunnel simulation of surface pressure as applied to an embodiment of the present application.

### DETAILED DESCRIPTION OF THE EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

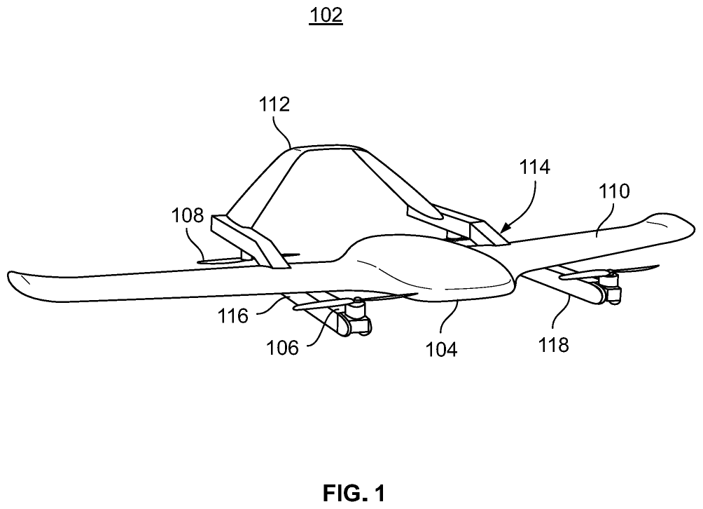

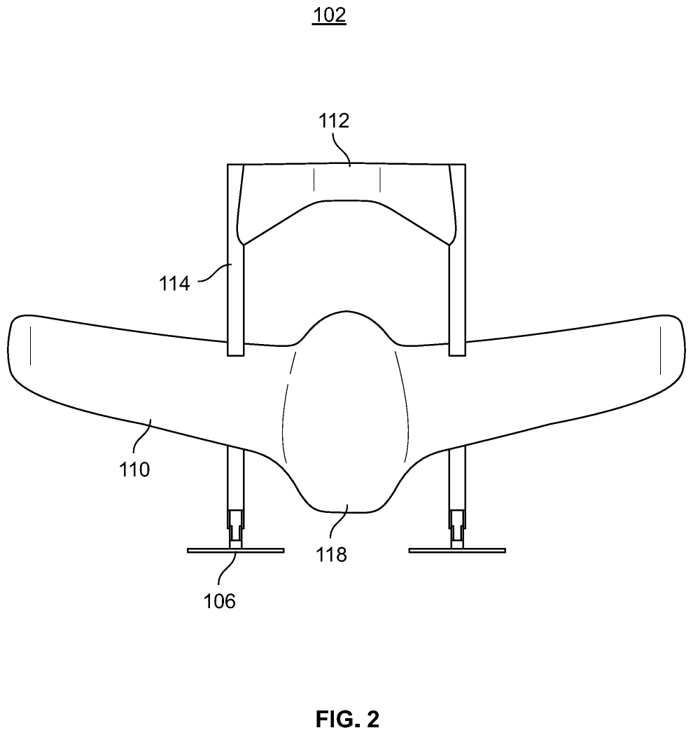

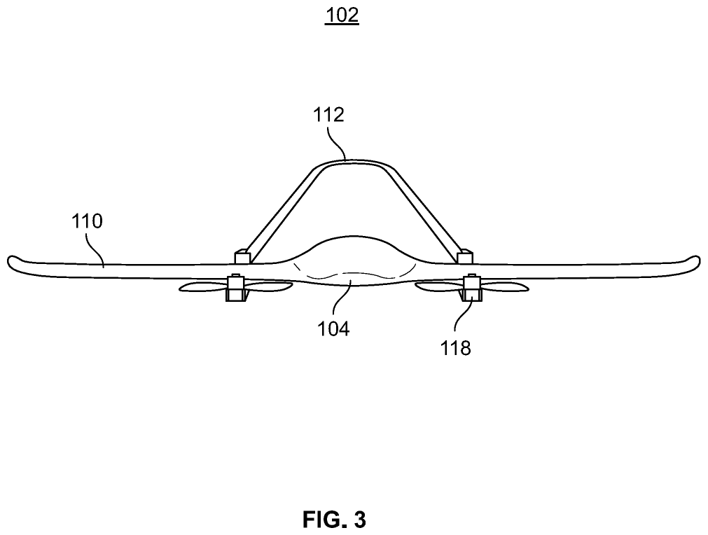

Referring now to FIGS. 1-4, there are multiple views of an embodiment of the present invention embodied as an unmanned aerial vehicle or UAV 102. The UAV 102 generally has a vehicle body 104, first set of rotors 106, a second set of rotors 108, a wing 110, a tail 112, and a boom 114 comprised of a first boom 116 and a second boom 118.

The vehicle body 104 is configured to be aerodynamic and supports the wings 110 of the UAV 102. The exact shape and size of the vehicle body 104 and wings 110 may vary depending on the needs and qualities of the UAV 102 including but not limited to payload size/weight, range, materials used, velocity, and the like or some combination thereof. In at least one embodiment, the vehicle body 104 and wings 110 contain various sensors configured to sense at least one property of the environment in which the UAV 102 operates. The vehicle body 104 and the wings 110 may be formed from the same or a different material such as carbon fiber, polymers, metals, wood, composites, or some combination thereof. Further, the wings 110 may be separable from the vehicle body 104 or may be integral with the vehicle body 104.

The tail 112 and boom 114 form a separate subsection of the UAV 102 which may then be coupled to an underside of the wings 110 of the UAV 102. In a preferred embodiment, there is a first boom 116 and a second boom 118 coupled by the tail 112. Each of the first boom 116 and the second boom 118 are substantially identical to one another. Each of the first boom 116 and the second boom 118 are configured to support one rotor of each of the first set of rotors 106 and the second set of rotors 108.

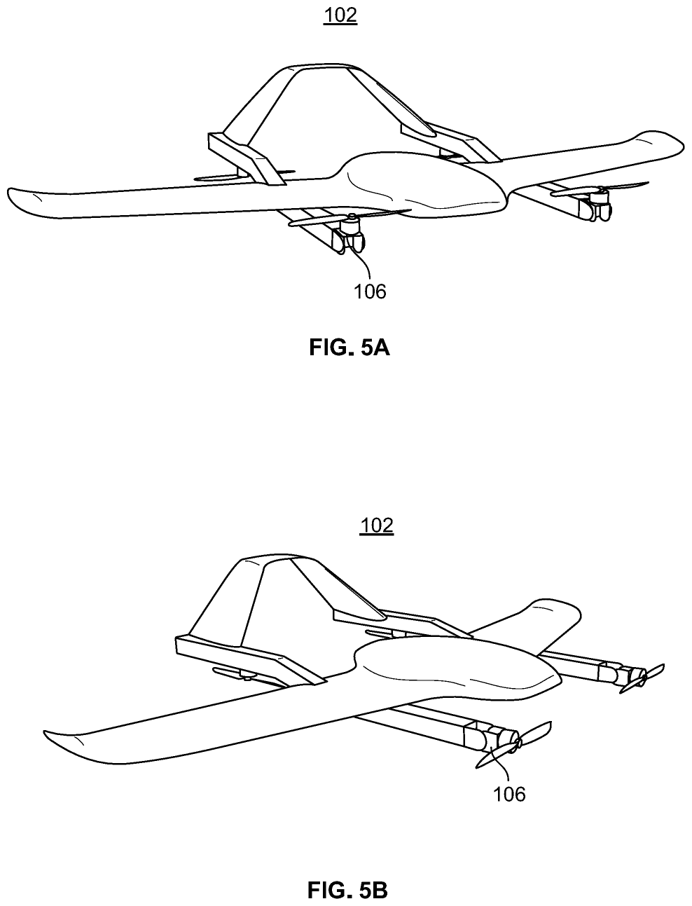

On a first end of each of the first boom 116 and the second boom 118, there is at least one rotor. This rotor is configured to be rotatable between a first position and a second position, the first position being substantially parallel to the boom and the second position being substantially perpendicular to the boom as shown in FIGS. 5A and 5B.

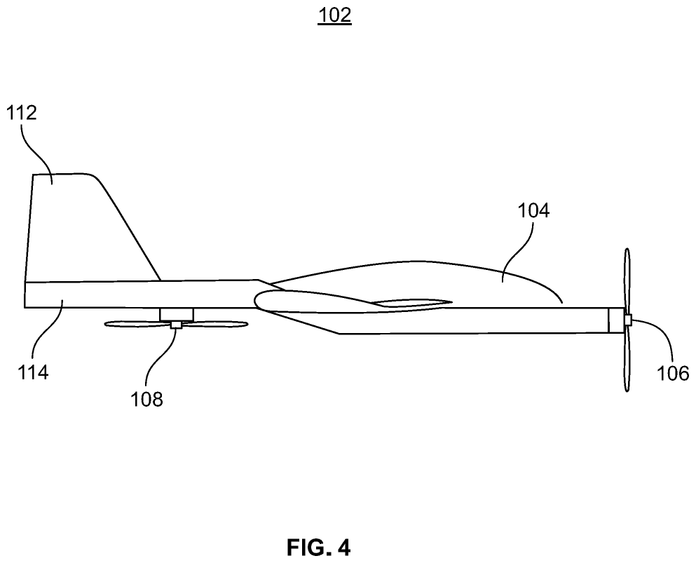

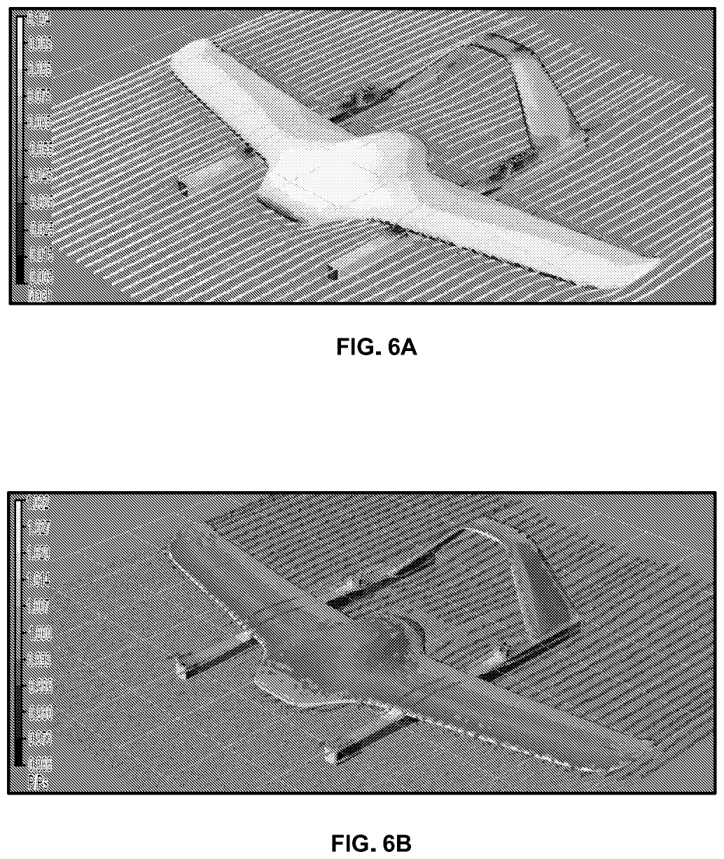

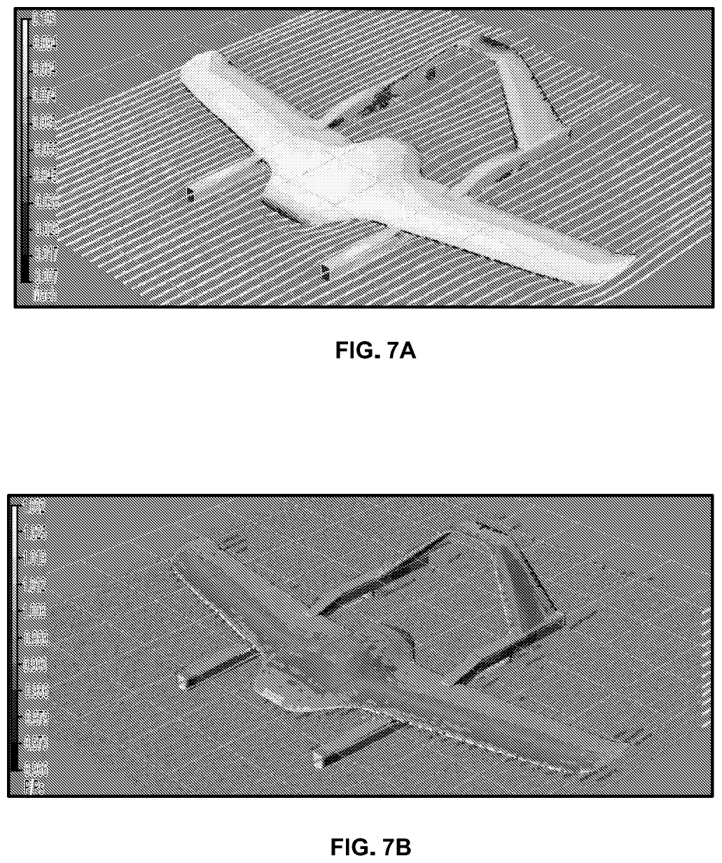

To a rear of the wing 110 are the rotors forming the second set of rotors 108 with one rotor being disposed on each of the first boom 116 and the second boom 118. As shown in FIG. 4, there is an upward rise or kink in each of the first boom 116 and the second boom 118. The upward rise begins before the trailing edge of the wing 110 and continues past the trailing edge of the wing 110. In at least one embodiment, the upward rise starts at a midpoint between a leading edge and a trailing edge of the wing 110. As further described herein, particularly with reference to FIGS. 6A-7B, the upward rise functions as a fairing structure for the UAV 102.

At or near a second end of each of the first boom 116 and the second boom 118, the tail 112 emanates from a top surface of each of the first boom 116 and the second boom 118 thereby coupling the first boom 116 and the second boom 118. The tail 112 further aids in providing stability in flight.

Referring now to FIGS. 5A and 5B, shown are a UAV 102 in a take-off/landing configuration (FIG. 5A) and a flight or cruise configuration (FIG. 5B).

When in a take-off/landing configuration both the first set of rotors 106 and the second set of rotors 108 are actively operational or generating thrust. However, note that in this configuration, the first set of rotors 106 and the second set of rotors 108 are in opposing orientations. That is the first set of rotors 106 faces upwards and the second set of rotors 108 faces downwards. Further, it is of importance to note that each set of rotors and each rotor within the set of rotors may be independently controllable thereby allowing each rotor of the UAV 102 to generate the same or different thrust as another rotor of the UAV 102. This configuration allows for the UAV 102 to take-off or land vertically rather than having to utilize a runway or other method of gaining flight. Once landed, the rotors can be ceased to be used and the UAV 102 retrieved.

However, once the UAV 102 has taken-off, the first set of rotors 106 can be rotated from the vertical or parallel configuration to a horizontal or perpendicular configuration as shown in FIG. 5B. This allows for the thrust generated from the first set of rotors 106 to move the UAV forwards in flight while the wing 110 generates lift. The rotation from the vertical to horizontal positions may be achieved by a number of means and may utilize conventional motors such as a servo motor. Notably, when in this configuration, the second set of rotors 108 are stopped or cease to produce thrust as the fixed orientation of the rotors would not generate thrust conducive for flight. Further, the second set of rotors 108 are configured to, when in flight/cruise mode, align the at least two blades of each of the rotors of the second set of rotors 108 with the boom to which the rotor is coupled. For example, as shown in FIG. 5B, the blades of the second set of rotors 108 are in line with the length of the first boom 116 and second boom 118, respectively. Further, the position of the second set of rotors 108 “behind” the upward rise in the boom 114 reduces drag and increases other flight desirable qualities of the UAV 102.

Referring now to FIGS. 6A-7B, shown are data from a simulated wind tunnel testing of a conventional or known UAV (FIGS. 6A-6B) and data from a simulated wind tunnel testing of an embodiment of the present application (FIGS. 7A-7B). The parameters of each of the UAVs is shown below in Table 1.

TABLE 1

| | | UAV of the |
|---|---|---|
| | Known UAV | present application |
| | (FIGS. 6A-6B) | (FIGS. 7A-7B) |
| Length × Width × Height (cm) | 68.1 × 119.4 × 15.7 | 67.3 × 119.4 × 18.5 |
| Drag (N) | 17.4 | 16.2 |
| Lift (N) | 251 | 265 |
| Left (N) | 1.15 | 0.4 |
| Roll Moment (Nm) | −0.08 | 0.06 |
| Pitch Moment (Nm) | 66.4 | 66.8 |
| Yaw Moment (Nm) | −0.09 | −0.007 |

The data generated by the simulated wind tunnel shows the effects of drag on known UAVs and that of the present application. To generate the data, a commercial computational fluid dynamics software, MicroCFD® 3D Virtual Wind Tunnel, was used. As noted, this software was used to simulate the aerodynamics of two similar UAV models: 1) a conventional UAV design where rear rotors are placed on top of straight booms; and 2) an embodiment of the present application, where the rear (second set) of rotors are placed on an underside of the boom and behind an upward rise or kink in the boom structure. These two UAV models are of identical wingspan and fuselage, but the known UAV is slightly longer and the embodiment of the present application has a slightly higher tail, as dictated by the respective design differences between the UAVs.

As shown in FIGS. 6A-7B, the first set of rotors are removed, as such do not generate drag during cruise flight and are further not the subject of the present application. For the simulated wind tunnel simulation parameters, the air flow speed was set to 0.1 Mach (76.8 mile per hour), static air pressure was 1013 hPa, the temperature was 15 degrees Celsius, the gas constant was 287 Joule/(kilogram Kelvin), and the specific heat ratio was 1.4. FIGS. 6A-6B shows the air speeds (FIG. 6A) and pressure (FIG. 6B) near the surface of the known UAV. FIGS. 7A-7B shows the air speeds (FIG. 7A) and pressure (FIG. 7B) near the surface of the UAV subject to the present application.

In all of FIGS. 6A-7B, stream particle lines are displayed on a horizontal plane near the rear (second set) rotors. The stream particle lines in FIGS. 7A-7B indicates that the upward rise portion of the boom functions as a fairing structure for the rotors behind it. In addition, by comparing FIGS. 6B and 7B, it is apparent that the air pressure on the front surface of the rear rotors is higher in the known design than in the design of the present application. The data demonstrates the proposition that the upward rise in the boom design helps streamline portions of the aircraft. The force and moment calculated from these simulations are shown in Table 1 as well. Note that the total drag is 17.4 Newton for the known UAV, vs. 16.2 Newton for the UAV of the present application. In short, the UAV of the present application provides about a 6.9% reduction in total drag over known UAV design(s).

Although this invention and its embodiments have been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An aerial vehicle comprising:
a vehicle body;
a first set of rotors,
wherein the first set of rotors are configured to reside in a first position and a second position; and
a second set of downward facing rotors,
wherein the second set of downward facing rotors are configured to reside in a first state and a second state.

2. The aerial vehicle of claim 1 wherein the first position of the first set of rotors is in an upward facing position.

3. The aerial vehicle of claim 1 wherein the second position of the first set of rotors is in a forward-facing position.

4. The aerial vehicle of claim 1 wherein the first state of the second set of downward facing rotors is in an operative state.

5. The aerial vehicle of claim 1 wherein the second state of the second set of downward facing rotors is in a non-operative state.

6. The aerial vehicle of claim 1 further comprising a wing and a boom, wherein the boom is coupled to an underside of the wing.

7. The aerial vehicle of claim 6 wherein the boom has an upward rise at a trailing edge of the wing.

8. An aerial vehicle comprising:
a vehicle body having a wing and a boom,
wherein the boom has an upward rise at a trailing edge of the wing;
a first set of rotors,
wherein the first set of rotors are configured to reside in an upward facing and
a forward-facing position; and
a second set of downward facing rotors,
wherein the second set of rotors are configured to reside at an apex of the upward rise in the boom.

9. The aerial vehicle of claim 8 wherein the boom comprises a first boom and a second boom.

10. The aerial vehicle of claim 9 wherein the first boom and the second boom are coupled via a tail.

11. The aerial vehicle of claim 8 wherein each of the first set of rotors and the second set of rotors has at least two blades.

12. The aerial vehicle of claim 8 wherein each rotor of the first set of rotors and the second set of rotors has two blades.

13. The aerial vehicle of claim 8 wherein a position of the second set of rotors is configured to reduce drag of the second set of rotors when not in use.

14. The aerial vehicle of claim 8 further comprising a coupling member configured to allow for rotation of the first set of rotors from an upward facing position to a forward-facing position.

15. An aerial vehicle comprising:
a vehicle body having a wing and a boom,
wherein the boom is coupled to an underside of the wing, and
wherein the boom has an upward rise at a trailing edge of the wing;
a first set of rotors rotatably coupled to the vehicle body via a coupling mechanism,
wherein the first set of rotors are configured to reside in an upward facing and
a forward-facing position; and
a second set of downward facing rotors,
wherein the second set of rotors are configured to reside at an apex of the upward rise in the boom, and
wherein blades of the second set of downward facing rotors are configured to be aligned with the boom when not in use.
